(19) United States
(12) Patent Application Publication
(10) Pub. No.: US 2009/0282113 A1
(43) Pub. Date: Nov. 12, 2009

(54) Apparatus and method for providing a photocopier with e-mail capability

(76) Inventors: Steven Blakeman, Youngstown, OH (US); Bryan A. Blakeman, Youngstown, OH (US)

Correspondence Address: H. JAY SPIEGEL - H. JAY SPIEGEL & ASSOCIATES, P.O. BOX 11, MOUNT VERNON, VA, 22121, US

(21) Appl. No.: 12/149,620

(22) Filed: May 6, 2008

(51) Int. Cl. G06F 15/16

(52) U.S. Cl. 709/206

(57) ABSTRACT

An apparatus and method provides a photocopier with E-mail capability by integrating a system into the photocopier. The system is made to be compatible with the software programming of a multi-functional product (MFP) to allow the MFP to communicate with XML web pages. In this way, the MFP is permitted to ask an external application running on a server to do desired tasks and to see and interact with the application from the touch screen of the MFP which is typically populated with light emitting diodes (LEDs). When the features of the system are provided in the MFP and when those features are selected from the touch screen, a special screen opens up on the MFP allowing the user to enter one or more e-mail addresses as well as a subject line and a message as would be the case in any e-mail. When a send feature is activated, the MFP's settings are used to create an electronic file which has been scanned and create an e-mail attachment which is then sent through an external server using “File-Max Mail,” the present invention's trademark. The system is provided with an Internet connection so that when using the features of the present invention, an e-mail plus attachment can be sent to one or more third party recipients. A copy of the e-mail as sent is also forwarded to a designated account or a plurality of designated accounts of the user.

### BACKGROUND OF THE INVENTION

The present invention relates to an apparatus and method for providing a photocopier with e-mail capability. A photocopier out of the box can have many features. Copiers on the market presently are often termed multi-functional products (MFPs). MFPs can commonly accomplish one or more of the following functions: copier functions, printing, scanning, and sending and receiving facsimiles. Typical photocopiers have a display screen and means for inputting commands consisting of the display screen comprising a touch screen.

Some photocopier manufacturers incorporate into their products application builder software consisting of a software developer's kit (SDK) that allows a common MFP to have applications built in allowing network devices and processes to communicate with the MFP to accomplish tasks that an MFP has not historically been able to accomplish. Manufacturers offering the SDK in their photocopiers are in the distinct minority presently. With an SDK, a developer an design third party software or applications that utilize the MFP to accomplish new and unusual tasks. In this instance, Microsoft.NET is the programming language that may be used. If desired, the Redemptions program by Dmitry Streblechenko may be employed to enhance performance and minimize security risks through OUTLOOK.

Around 1977, work on a layered model of network architecture began in the American National Standards Institute (ANSI). This architecture was later termed the open systems interconnection basic reference model, or “OSI model” as an abbreviation. The OSI model is often used in photocopiers and consists of a layered abstract description for communications and computer network protocol design. In a typical OSI model, a seven layer model is typically employed including from top to bottom (most complex to least) the following layers: Application, Presentation, Session, Transport, Network, Data Link and Physical. Each layer consists of a collection of related functions, each of which provides and receives services to the layer(s) adjacent it and receives services from the layer below it. Again, such network architecture is often used in photocopiers. The functions of an MFP as described above when provided in combination result in a photocopier with advantageous versatility. However, such a photocopier still has its limitations. One limitation is the inability to directly send e-mails to recipients from various e-mail accounts with scanned documents attached. If an MFP photocopier were to include that capability, its versatility would be dramatically enhanced. It is with this thought in mind that the present invention was developed.

### SUMMARY OF THE INVENTION

The present invention relates to an apparatus and method for providing a photocopier with e-mail capability. The present invention includes the following interrelated objects, aspects and features:

1) In a first aspect, the present invention is a system including E-mail application software made to be compatible with the software programming of a multi-functional product (MFP) to allow the MFP to communicate with extensible markup language (XML) and other text-based pages. In this way, the MFP is permitted to ask an external application running on a server to do desired tasks and to see and interact with the application from the touch screen of the MFP which is typically populated with light emitting diodes (LEDs).

2) When the features of the present invention are provided in the MFP and when those features are selected from the touch screen, a special screen opens up on the MFP allowing the user to enter one or more e-mail addresses as well as a subject line and a message as would be the case in any e-mail. When a send feature is activated, the MFP's settings are used to create an electronic file which has been scanned and create an e-mail attachment which is then sent through an external server using “FileMax Mail,” the present invention's trademark.

3) In accordance with the teachings of the present invention, the system is provided with a signal port comprising an Internet connection so that when using the features of the present invention, an e-mail plus attachment received from the MFP can be sent to one or more third party recipients. The signal port can also facilitate retrieval of documents from the Internet and saving them in the system's memory to later be retrieved to become an attachment to an E-mail.

4) In accordance with the teachings of the present invention, the e-mail feature incorporated into the MFP is also concurrently an e-mail account owned by an MFP user and accessible via their personal computer or other e-mail device. Thus, when the MFP sends an e-mail, with or without an attachment, a copy of the e-mail as sent will appear in the e-mail account of the user in their sent items folder including a time stamping as if the e-mail had been sent from the personal computer's e-mail program. If, in some circumstances, the e-mail program does not allow access by the MFP to the sent items folder, instead, a copy of the e-mail sent by the MFP will be received in the inbox of the user so that appropriate proof has been provided that an item had been sent along with an exact copy of what was sent including any and all attachments.

5) The present invention is designed to be compatible with most popular web based e-mail programs like those administered by Google, Yahoo, Microsoft (Hotmail), America Online, and others. It is also designed to be compatible with other SMTP e-mail services. Versions compatible with Microsoft Exchange which is an Enterprise level e-mail program for larger businesses are also developed. The inventive system may access the lightweight directory access protocol (LDAP) using the System Directory Services namespace provided by Microsoft to directly communicate with their network's global address book. When the present invention is incorporated into an MFP, the system is provided with an Internet connection via the external server. The Internet connection can then be of any desired type such as DSL, Cable, etc., to facilitate sending of E-mails.

6) Each version of the present invention permits a user to create a log in and remembers the user each time they return to the MFP. Each version populates a user address book in the system's memory with intelligence that auto-populates the address with every address to which an e-mail has been sent so as to provide quicker access and efficient selection of commonly used addresses. During the e-mail process in accordance with the teachings of the present invention, a copy of the e-mail attachment along with the user who sent it and a date stamped file name may be provided to any network share folder provided by the network administrator. This facilitates adherence to potential compliance issues, compliance with regulations, and security of internal information.

7) With the present invention installed on a server, the inventive software aspects facilitate its operation. In a first aspect, the inventive software requires a user to first register before being able to use the e-mailing capability. A log-in screen is provided at which a user must provide a user name and a password. If the user is an existing user, he or she may proceed to the main menu of the inventive system. If not, the screen prompts the user to register by providing any information desired by the administrator so that users can be verified and so that security of the system can be maintained.

8) Once a user has properly registered and has used their registration information to access the inventive application, the user may also add one or more additional e-mail addresses to their account. For this purpose, a select mail profile screen is provided which when accessed, conveys the user to a new sender e-mail account screen, where the new e-mail address can be added.

9) The system also permits a user to edit one or more e-mail addresses. Once successfully logged into the system, the user follows prompts on the screen, accesses the e-mail address for which editing is required from the memory, and uses the keyboard on the screen or an externally attached keyboard to appropriately edit the e-mail address and re-save it. Security features are included to ensure that only the authorized owner of the e-mail address or administrative user is permitted to edit it.

10) The system also permits deletion of an e-mail address by a user. After successfully logging into the application, the user gains access to the e-mail address from the memory for which deletion is desired and follows the prompts on the screen to delete the e-mail address. Appropriate security features are included to ensure that only an authorized user who is the owner of the e-mail address or administrative user is permitted to gain access for the purpose of deleting it.

11) When a user desires to scan one or more documents and send one or more e-mails, they must first log-in to the inventive application and system. A screen provides a list of potential sender (originator) e-mail addresses. The user chooses one of those addresses. A screen then prompts the user to enter the address or addresses of all desired recipients from the recipient e-mail addresses already pre-programmed into the system. If one or more of the desired recipient e-mail addresses is/are not pre-programmed into the system, the user is directed to another screen where the additional recipient e-mail address or addresses may be programmed into the system. Once all recipient e-mail addresses are programmed into the system, the desired recipient e-mail addresses and priority (To, CC, BCC) are chosen. Once they are chosen, a “subject” for the e-mail may be entered into the subject line. One or more documents that will be attachments to the e-mail are scanned by the MFP and the screen prompts the user to provide identifying file name(s) for each scanned image so that they may be saved in the system's memory for later retrieval for attachment to an E-mail. Thus, if the user desires to save the file or files that has/have been scanned, a screen includes prompts permitting separate saving of the file. Thereafter, the e-mail may be sent with or without one or more attachments retrieved from the memory. As explained earlier, a copy of the e-mail as sent is also forwarded to a designated account or a plurality of designated accounts of the user.

Accordingly, it is a first object of the present invention to provide an apparatus and method for providing a photocopier MFP user with e-mail capability by connecting it with a third party source.

It is a further object of the present invention to provide such an apparatus and method designed to communicate with and operate in conjunction with the MFP's features.

It is a further object of the present invention to provide such an apparatus and method in which a user may register including registering of a plurality of e-mail addresses.

It is a still further object of the present invention to provide such a device which permits a user to send e-mails including attachments from the display panel of an MFP connected to “FileMax Mail,” the present invention's trademark.

It is a yet further object of the present invention to provide such an apparatus and method in which multiple recipients may be sent e-mails simultaneously and in which a user may maintain several e-mail accounts for use in association with the inventive apparatus and method and the MFP.

It is a still further object of the present invention to provide such an apparatus and method in which the MFP scanner may scan attachments which will be forwarded to an external application used to deliver the E-Mail.

It is a still further object of the present invention to provide such an apparatus and method in which a record of all e-mails sent by the user is maintained in the MFP.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a logic diagram of the manner of incorporation of the present invention in an existing multi-functional product (MFP).

FIG. 2 shows a logic diagram explaining how a user registers with the inventive system.

FIG. 3 shows a logic diagram depicting how a user uses the inventive system to add an e-mail address.

FIG. 4 shows a logic diagram of the manner by which the inventive system permits editing of e-mail addresses.

FIG. 5 shows a logic diagram explaining how the system operates to delete one or more e-mail addresses.

FIGS. 6 and 7 show logic diagrams depicting how the inventive system facilitates scanning of documents and sending of e-mails.

FIG. 8 depicts the home screen used in accordance with the teachings of the present invention.

FIG. 9 depicts the user registration screen used in accordance with the teachings of the present invention.

FIG. 10 depicts the screen for registering a user displaying entry of an invalid password.

FIG. 11 shows the registration screen displaying when registration of a user has been completed.

FIG. 12 depicts the log-in screen.

FIG. 13 depicts the main menu screen.

FIG. 14 depicts the screen used to select an existing E-mail address, add a new E-mail address, edit an existing E-mail address, or delete an existing E-mail address.

FIG. 15 shows the screen used to select the mail profile the user wishes to associate with a new E-mail address that has been entered into the system.

FIG. 16 shows a screen permitting entry of a new E-mail address into the system.

FIG. 17 shows a screen permitting clicking on an E-mail address for the purpose of editing it.

FIG. 18 shows a screen used to edit the E-mail address.

FIG. 19 shows a screen used to delete an E-mail address.

FIG. 20 shows a screen confirming deletion of an E-mail address.

FIG. 21 shows a screen used to choose recipient E-mail addresses for a proposed E-mail.

FIG. 22 shows a screen permitting the user to choose a particular sender E-mail address.

FIG. 23 shows a screen permitting the user to confirm the recipients of an E-mail chosen with reference to FIG. 21.

FIG. 24 shows a screen permitting the user to provide a subject for an E-mail and the body of the E-mail message.

FIG. 25 shows a screen permitting entry of a file name of a scanned image file to permit the scanned image to be saved for later attachment to an E-mail message.

FIG. 26 shows a screen permitting browsing of a memory to access a previously saved file of an image to be used as an attachment.

FIGS. 27-29 show screens used to provide settings for a scanner.

FIG. 30 shows a screen used to scan and send an E-mail.

FIG. 31 shows a screen confirming successful sending of an E-mail and instructing the user as to the next steps.

### SPECIFIC DESCRIPTION OF THE PREFERRED EMBODIMENT

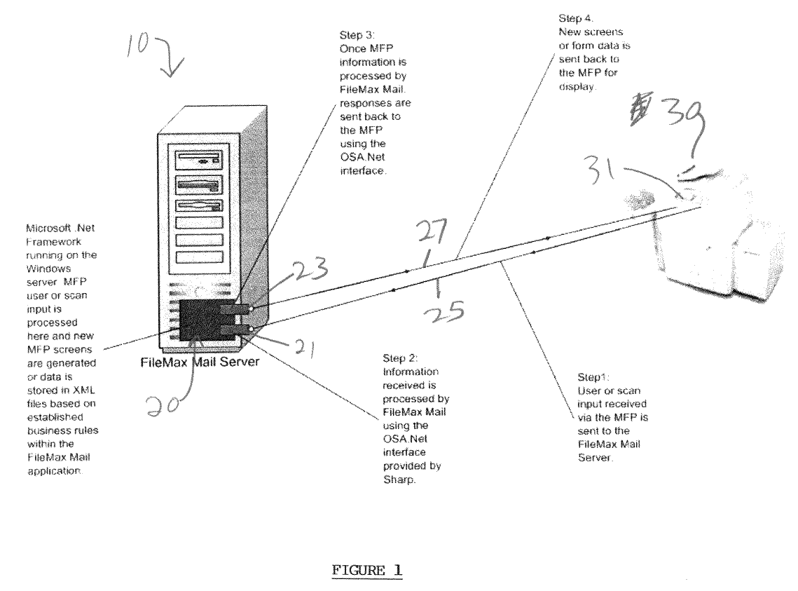

Reference is first made to FIG. 1 which shows the manner by which the present invention is incorporated into an existing multi-functional product (MFP). With reference to FIG. 1, a Microsoft.net framework is generally designated by the reference numeral 10 and the inventive system is generally designated by the reference numeral 20 and includes an input port 21 and an output port 23 combining to create a signal port. These ports receive data from and to the MFP 30, respectively, via the schematically represented connections 25 and 27. The system also has an internal memory. As should be understood, the MFP 30 is connected to the Internet via any suitable Internet connection. As a first step in the operation of the present invention, the MFP is directed to either scan a document placed in its input tray or to retrieve a document from the Internet. In either case, that document once scanned or retrieved will be an attachment to an E-mail to be sent by the user. Once the document has been either scanned by the MFP 30 or retrieved under control of the system 22, data corresponding to the document is transmitted to the mail server 20 via the connection 25 and the port 21. The E-mail is composed and bundled with the attached document and the E-mail and attachment are sent via the port 23 and the connection 27 back to the MFP 30. The MFP has a display 31, typically a touch screen, that displays the E-mail plus the file name given by the user for the attachment. The display 31 also displays the E-mail address of the sender and all E-mail addresses for the receivers that are incorporated into the E-mail as explained in greater detail hereinafter. The system 22's memory stores scanned documents, documents retrieved from the Internet, user names and passwords, E-mail addresses for senders and recipients, and other useful information.

The display screen 31 on the MFP 30 includes an area that may be activated to cause the E-mail to be sent. Concurrently, a blind copy of the E-mail is also sent to the E-mail account of the sender that is typically operated from a separate personal computer (not shown). In this way, the sender may keep a record that the E-mail has been sent.

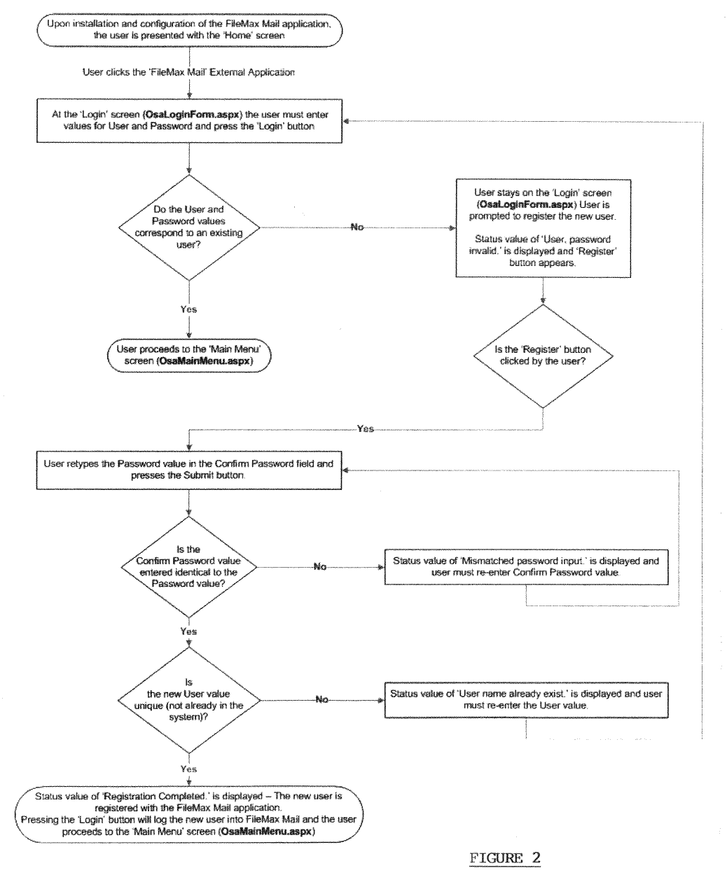

FIG. 2 shows a logic diagram explaining how a user facilitates registration with the inventive system. As shown, once the inventive system is installed in the manner described in FIG. 1, the user is presented with a home screen (FIG. 8) and clicks on the external application button on the screen. A log-in screen (FIG. 12) is provided that facilitates entry of values for the user's name and password. Once that information is inputted, a log-in button is pressed to cause the information to be entered. Once the information is entered, the system checks its memory to see whether the information entered corresponds to an existing user or password. If so, the user can proceed to a main menu screen and continue on using the system. If not, another screen is accessed (FIGS. 9-11) which requires the user to provide additional information facilitating their registration. Once that is completed as shown in FIG. 2, the user is registered and can then start using the system.

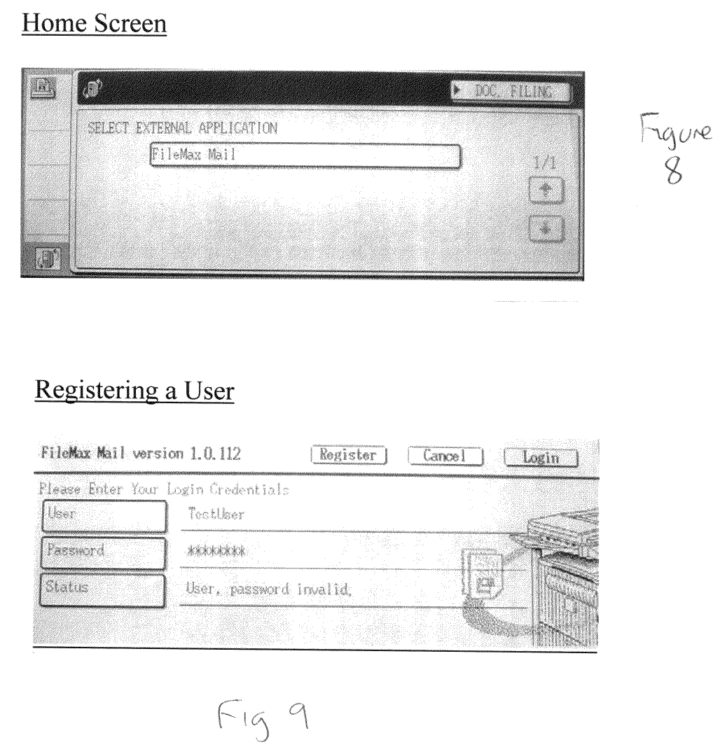

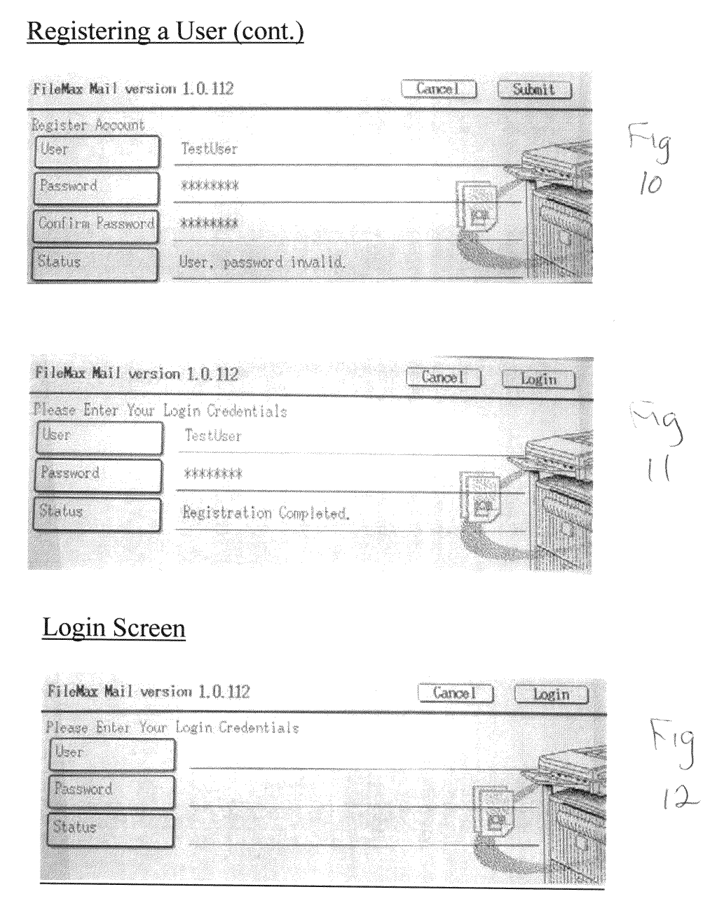

With reference to FIG. 3, a user may provide multiple E-mail addresses, any one or more of which may be used at any given time with the system. With reference to FIG. 3, upon successful log-in into the inventive application, a main menu screen (FIG. 13) is accessed and the steps shown in FIG. 3 are taken to facilitate adding one or more new E-mail address (see FIG. 14). As shown, the user is taken to a select mail profile screen (FIG. 15) and is required to click the mail profile associated with the new E-mail address to add, whereupon the user is presented with the new sender E-mail account screen (FIG. 16) and the new E-mail address can be added and saved in the memory. Security features to protect the integrity of the system are also explained in FIG. 3.

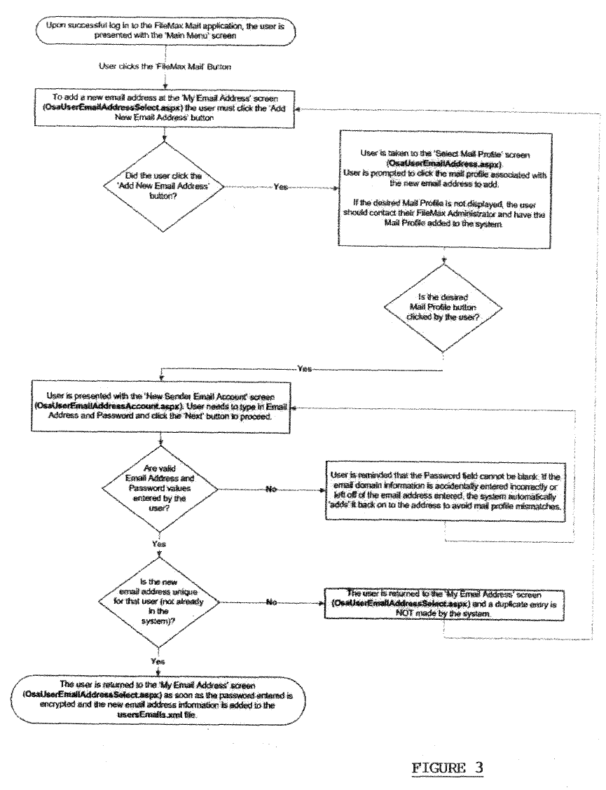

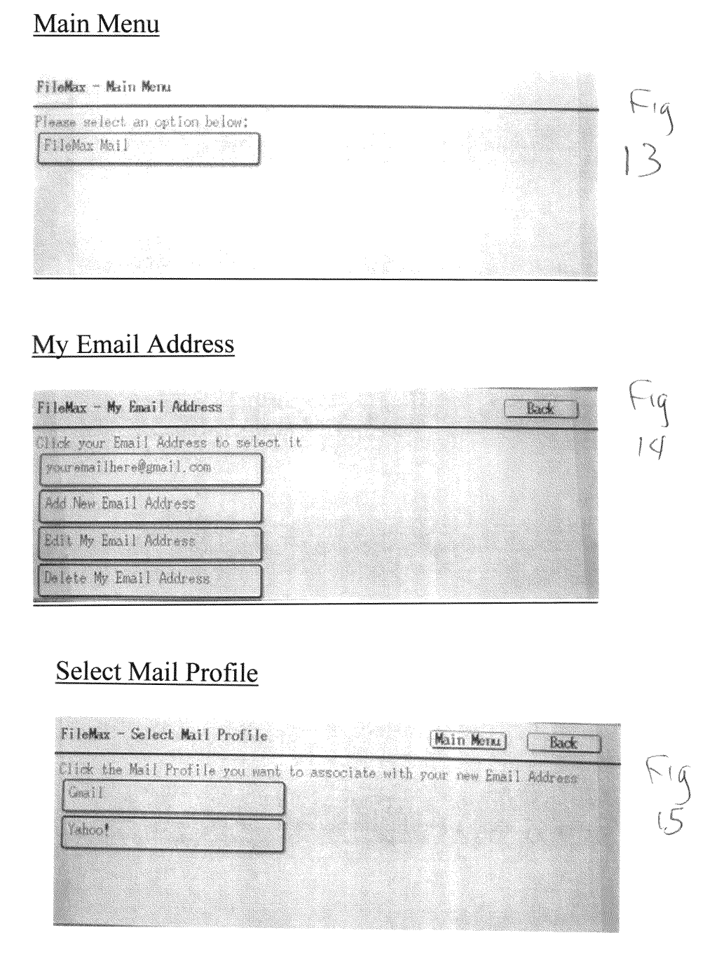

With reference to FIG. 4, it is also possible to edit an E-mail address that was already provided by accessing the appropriate screen (FIGS. 14, 17 and 18). E-mail addresses need to be edited if (1) a mistake has been made in the E-mail address when it was originally entered or (2) if the E-mail address changes and the user wishes to enter the changes. As shown in FIG. 4, after successfully logging in to the system, the user clicks on an edit my e-mail address button (FIG. 14), and is taken to an edit my e-mail address screen (FIGS. 17-18) and the desired E-mail address is accessed, edited, and re-saved into the system. Other security aspects of the procedure are also shown in FIG. 4.

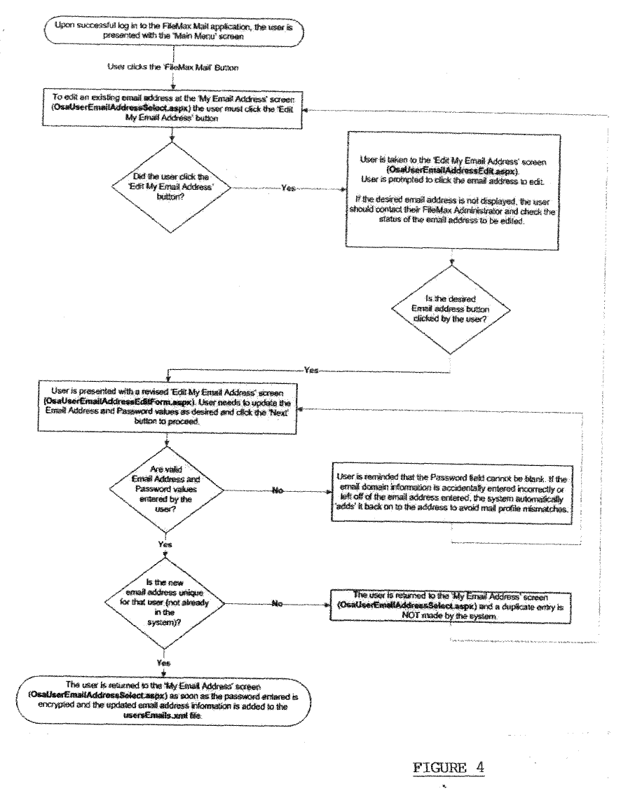

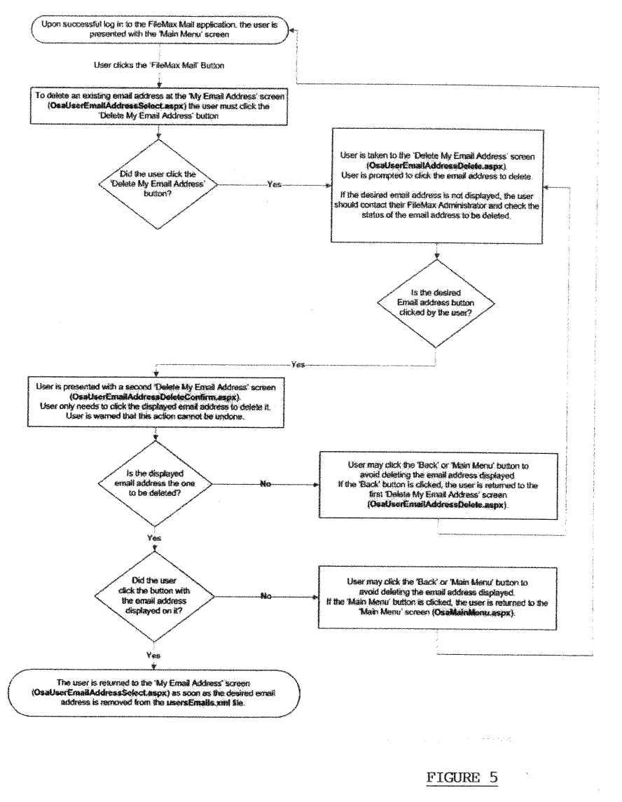

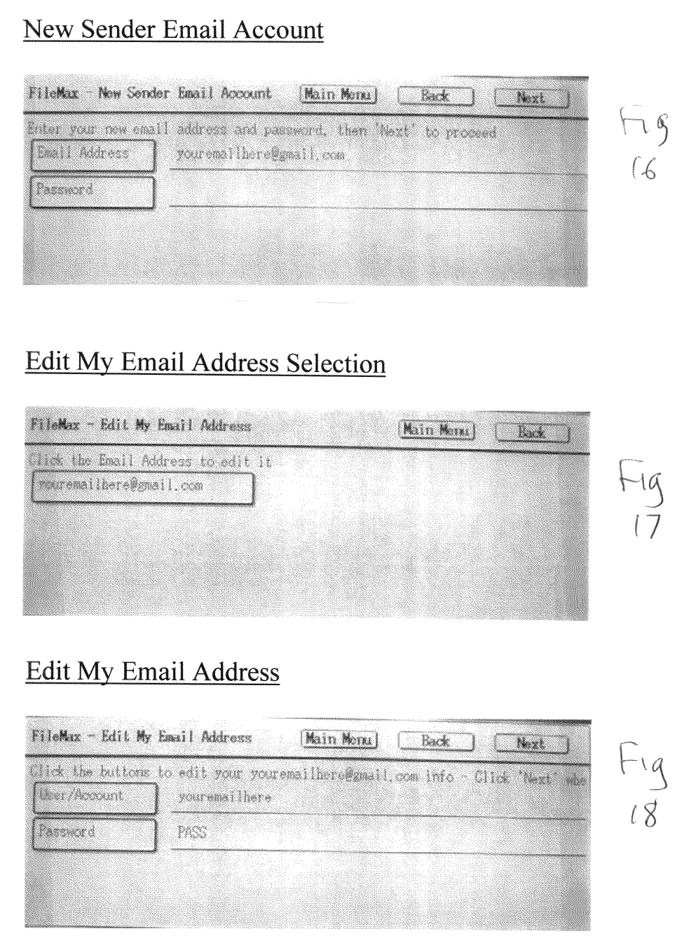

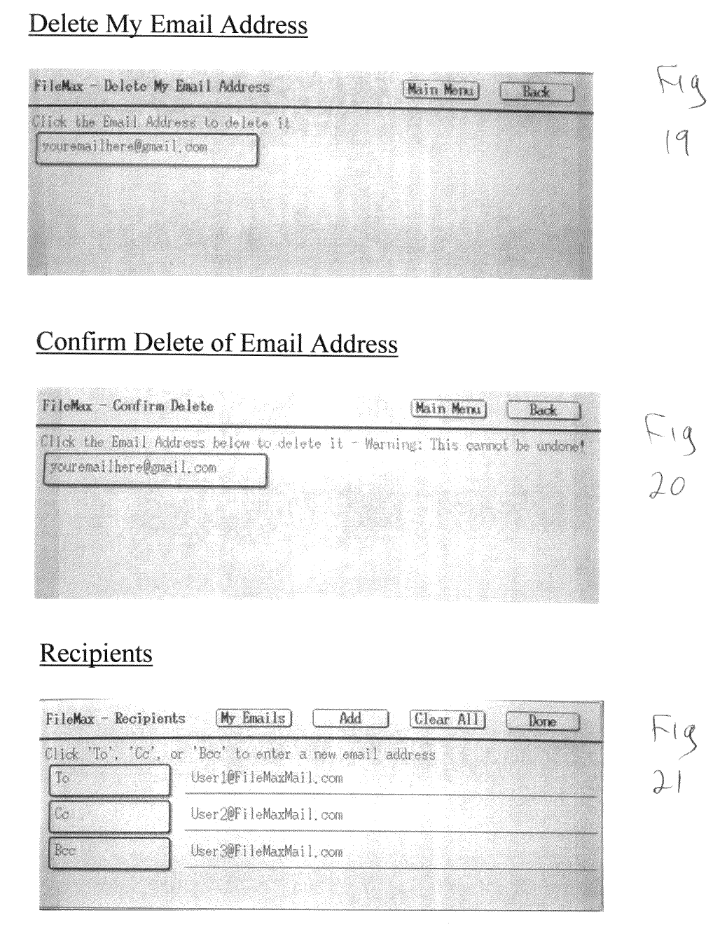

If the user desires to delete an E-mail address, this task is accomplished as shown in FIG. 5. After the user successfully logs in to the system, the user clicks on a delete my e-mail address button and is taken to a delete my e-mail address screen (FIG. 19). The “Confirm Delete” screen (FIG. 20) confirms deletion of an E-mail address, whereupon the desired E-mail address is accessed and deleted once the button is clicked.

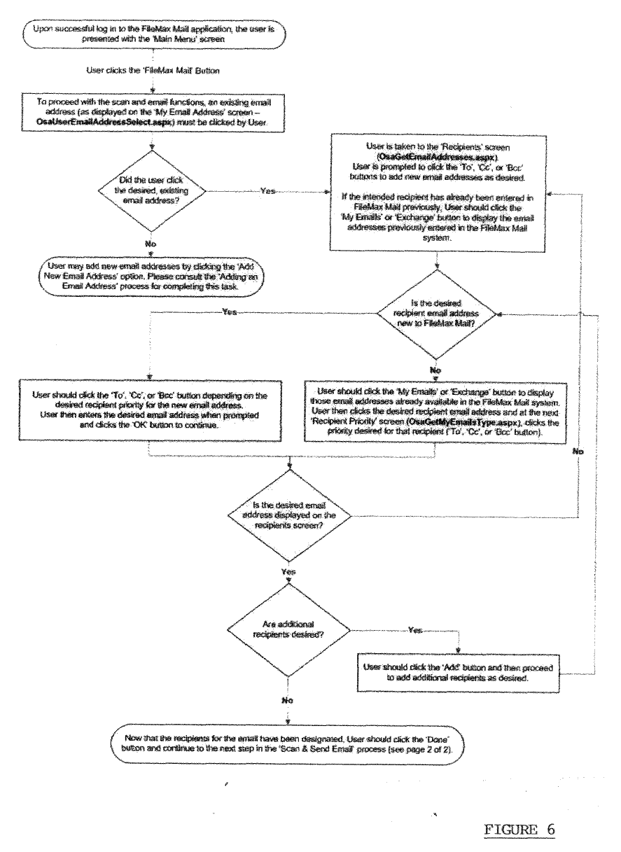

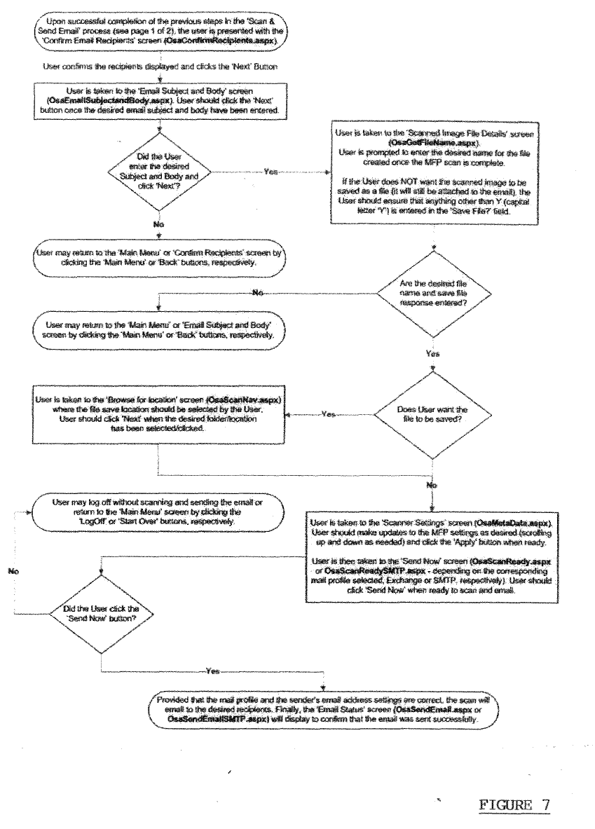

FIGS. 6 and 7 explain how E-mails with or without attached documents are sent in accordance with the teachings of the present invention. As explained in FIG. 6, upon successful log-in into the inventive system, the user is presented with a main menu screen (FIG. 13). The mail button is pushed and a listing of possible sender E-mail addresses from the memory is displayed (FIG. 14). The E-mail address that the user desires to use as the sender's E-mail address is clicked, whereupon the user is taken to the recipient's screen (FIG. 21), there the user is prompted to provide the recipient addresses and addresses where copies are going to be sent, whether overt copies or blind copies. A further screen (FIG. 23) confirms E-mail recipients. Once the system verifies that all the addresses requested are within the system, the process continues with reference to FIG. 7.

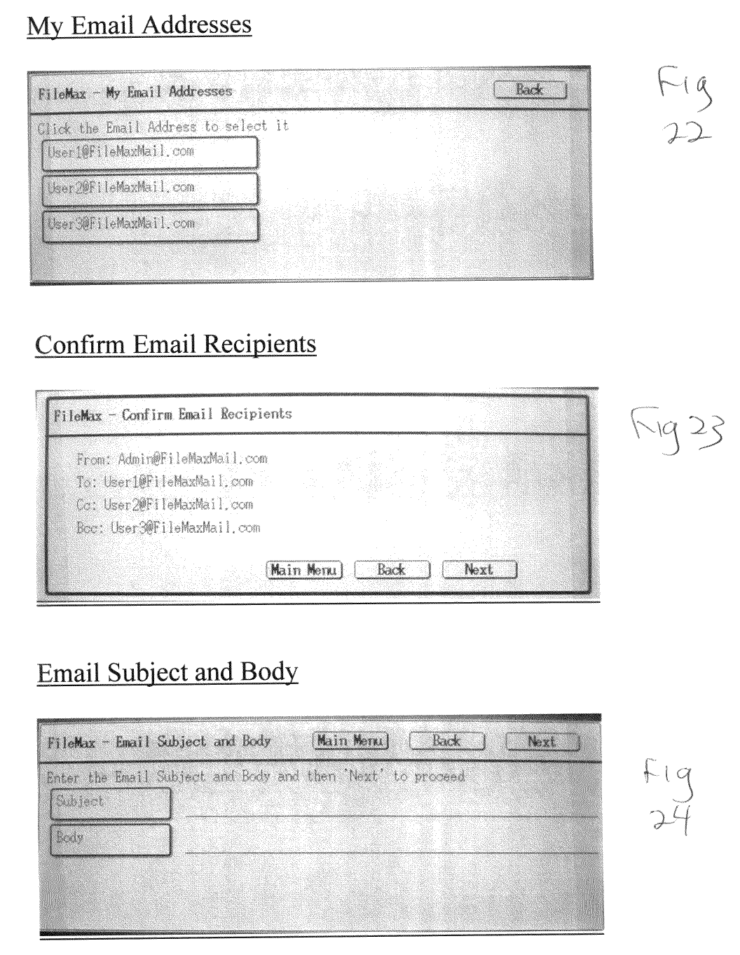

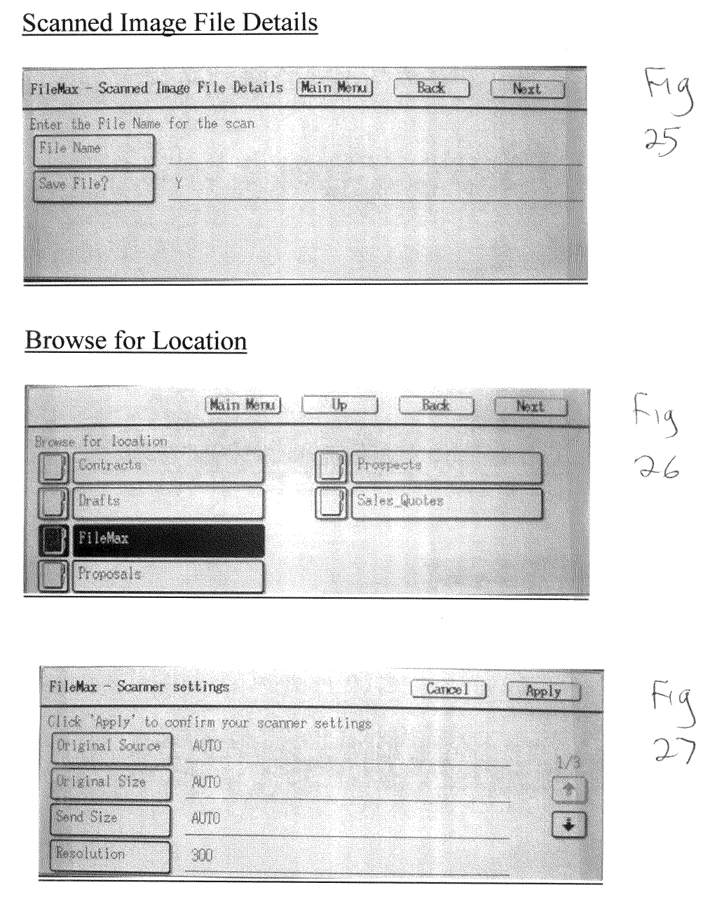

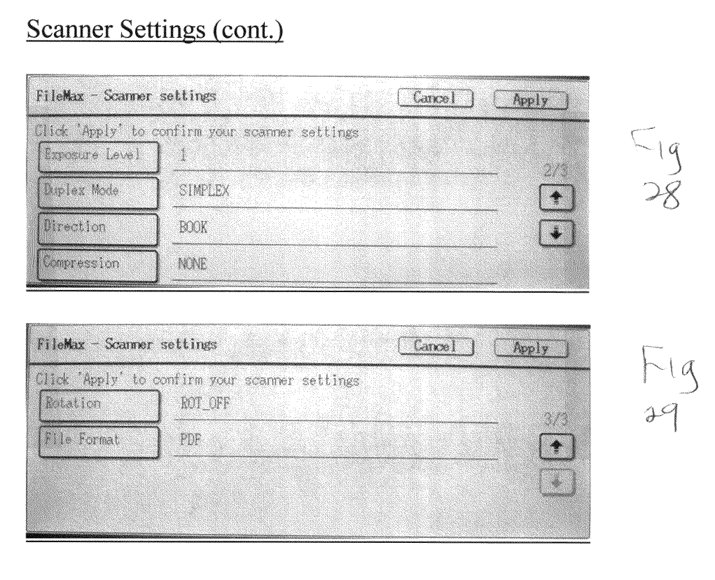

As shown in FIG. 7, once the sender and recipients are confirmed, the user is taken to an E-mail subject and body screen (FIG. 24) where the subject may be entered and the body may be provided. Thereafter, the user is taken to a screen (FIG. 25) where the name of a file pre-saved in the system's memory may be entered so that file may be named and saved at a desired location. As explained above, the file is either derived from a document scanned by the MFP or accessed from the Internet and saved as a result. Another screen (FIG. 26) may be accessed if a file was previously saved and the user wishes to browse the memory or other storage location (i.e., folders on the server) to access the file and attach it to the E-mail. This step may be skipped if an E-mail is being sent without an attachment. However, logically, the user would most likely desire to use the inventive system where an attachment is being used given the connection of the MFP to the Internet and the MFP's use as a scanner to scan and save documents that are going to be attachments to E-mails. FIGS. 27-29 show screens that are accessed and used to adjust scanner settings, as shown.

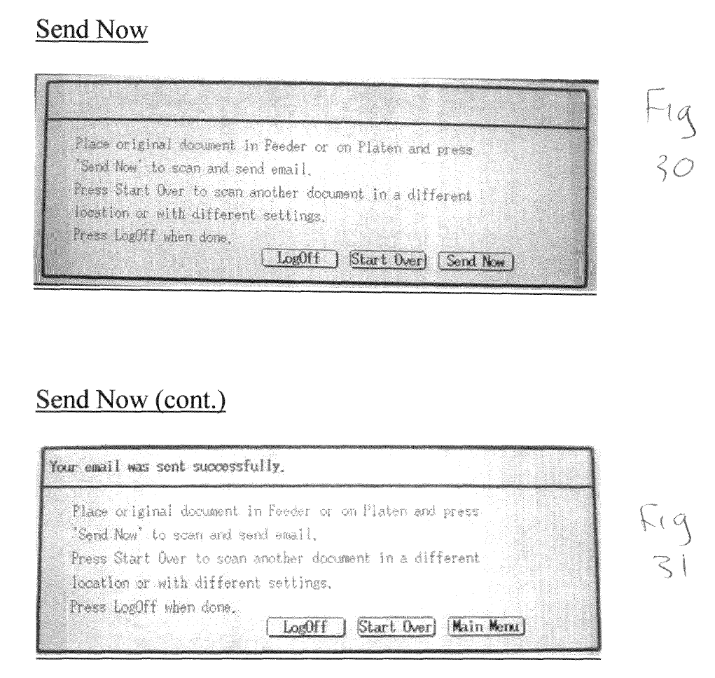

Thereafter as explained in FIG. 7, eventually the user arrives at a send now screen (FIG. 30) where the E-mail with its attachments (once scanned and saved) may be sent. As explained above, once the E-mail has been sent, it is also delivered to the send box from the user's separate E-mail account so that a record of the E-mail having been sent is provided to the user. A further screen (FIG. 31) confirms the E-mail has been sent.

Thus, as explained above, a user may employ the inventive system and follow the inventive method to employ an MFP to scan documents and files, some of which have been acquired from the Internet, incorporate them as attachments to E-mails, and send E-mails to third party recipients.

Accordingly, an invention has been disclosed in terms of a preferred embodiment thereof which fulfills each and every one of the objects of the invention as set forth hereinabove, and provides a new and useful apparatus and method for providing a photocopier with E-mail capability of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. In a photocopier capable of copying, printing and scanning of documents, and having photocopier software programmed to facilitate control of said photocopier, said photocopier including a display screen and input means for inputting commands to facilitate control of functions of said photocopier, the improvement comprising a system associated with said photocopier permitting said system to send E-mails from a user of said photocopier to one or more recipients, comprising:
a) E-mail application software compatible with said photocopier software and programmed to control E-mail functions using said photocopier;
b) said E-mail application software causing one mode of said display screen to display an option of accessing said system;
c) said input means including capability of facilitating access to said system;
d) said system having a signal port connected to a global computer network to send and receive signals with respect to said global computer network;
e) said system, when accessed, operating in conjunction with said photocopier to facilitate sending of E-mails from selected senders to selected recipients via said signal port and global computer network.

2. The improvement of claim 1, wherein said display screen and input means comprise a touch screen.

3. The improvement of claim 2, wherein said E-mail application software facilitates control of retrieval of documents from said global computer network intended as attachments to E-mails.

4. The improvement of claim 3, wherein said E-mail application software facilitates control of scanning of documents by said photocopier intended as attachments to E-mails.

5. The improvement of claim 4, wherein said E-mail application software facilitates saving said documents in a memory of said system for later retrieval to be attached to E-mails.

6. The improvement of claim 3, wherein said E-mail application software facilitates saving said documents in a memory of said system for later retrieval to be attached to E-mails.

7. The improvement of claim 2, wherein said E-mail application software facilitates control of scanning of documents by said photocopier intended as attachments to E-mails.

8. The improvement of claim 7, wherein said E-mail application software facilitates saving said documents in a memory of said system for later retrieval to be attached to E-mails.

9. The improvement of claim 1, wherein said system has a memory, said E-mail application software facilitating storing of user names and passwords in said memory.

10. The improvement of claim 1, wherein said system has a memory, said E-mail application software facilitating storing of E-mail addresses of senders in said memory.

11. The improvement of claim 1, wherein said system has a memory, said E-mail application software facilitating storing of E-mail addresses of recipients in said memory.

12. The improvement of claim 1, wherein said E-mail application software facilitates sending a record to a sender's E-mail account to record the sending of an E-mail by said photocopier to one or more recipients.

13. A method of sending E-mails with or without attachments using a photocopier, including the steps of:
a) providing a photocopier capable of copying, printing and scanning of documents, and having photocopier software programmed to facilitate control of said photocopier, said photocopier including a display screen and input means for inputting commands to facilitate control of functions of said photocopier;
b) providing a system associated with said photocopier permitting said system to send E-mails from a user;
c) providing said system with E-mail application software compatible with said photocopier software and programming said E-mail application software to control E-mail functions using said photocopier;
d) controlling said display screen to display an option of accessing said system;
e) facilitating access to said system using said input means;
f) connecting said system to a global computer network via a signal port; and
g) controlling said photocopier and system to facilitate sending of E-mails from selected senders to selected recipients via said signal port and global computer network.

14. The method of claim 13, wherein said display screen and input means comprise a touch screen.

15. The method of claim 2, further including the step of using said E-mail application software to control retrieval of documents from said global computer network intended as attachments to E-mails.

16. The method of claim 15, further including the step of using said E-mail application software to control scanning of documents by said photocopier intended as attachments to E-mails.

17. The method of claim 16, further including the step of using said E-mail application software to save said documents in a memory of said system for later retrieval to be attached to E-mails.

18. The method of claim 13, further including the step of providing said system with a memory, said E-mail application software facilitating storing of user names and passwords in said memory.

19. The method of claim 13, further including the step of providing said system with a memory, said E-mail application software facilitating storing of E-mail addresses of senders in said memory.

20. The method of claim 13, further including the step of providing said system with a memory, said E-mail application software facilitating storing of E-mail addresses of recipients in said memory.

21. The method of claim 13, further including the step of using said E-mail application software to send a record of sending of an E-mail by said system to a sender's E-mail account.
